(19) United States
(12) Patent Application Publication
(10) Pub. No.: US 2023/0331082 A1
(43) Pub. Date: Oct. 19, 2023

(54) FOUR-WHEEL-DRIVE VEHICLE

(71) Applicant: JTEKT CORPORATION, Kariya-shi (JP)

(72) Inventors: Akitomo IWATA, Kariya-shi (JP); Masaki MITA, Chiryu-shi (JP); Hiroshi YOSHIMOTO, Kashihara-shi (JP); Go NAGAYAMA, Toyama-shi (JP)

(73) Assignee: JTEKT CORPORATION, Kariya-shi (JP)

(21) Appl. No.: 18/191,169

(22) Filed: Mar. 28, 2023

(30) Foreign Application Priority Data
Apr. 14, 2022 (JP) 2022-066847

(51) Int. Cl. B60K 23/08

(52) U.S. Cl. CPC B60K 23/0808; B60K 2023/0816; B60K 2023/085

(57) ABSTRACT

A four-wheel-drive vehicle includes: an engine as a driving source; a right front wheel and a left front wheel as main driving wheels and a right rear wheel and a left rear wheel as sub-driving wheels that are driven by a driving force of the engine; a driving force transmission device that transmits part of the driving force of the engine to the right rear wheel and the left rear wheel; and a control device that controls the driving force transmission device. The control device is configured to, when the four-wheel-drive vehicle moves straight forward, adjust the driving force transmitted to the right rear wheel and the left rear wheel by the driving force transmission device so as to maintain a state where the magnitude of a front-rear force generated in the right front wheel and the left front wheel is greater than zero.

### CROSS-REFERENCE TO RELATED APPLICATION

This application claims priority to Japanese Patent Application No. 2022-066847 filed on Apr. 14, 2022, incorporated herein by reference in its entirety.

### BACKGROUND

### 1. Technical Field

This disclosure relates to a four-wheel-drive vehicle in which a driving force of a driving source is distributed and transmitted to main driving wheels and sub-driving wheels.

### 2. Description of Related Art

Conventionally, some four-wheel-drive vehicles that have front wheels turned by a turning device as main driving wheels and rear wheels as sub-driving wheels are capable of electronic control of a driving force transmitted to the sub-driving wheels. (For example, see Japanese Unexamined Patent Application Publication No. 2014-118074 (JP 2014-118074 A).)

The four-wheel-drive vehicle described in JP 2014-118074 A has an electronic control coupling disposed between a propeller shaft and a rear differential device. The electronic control coupling transmits, from the propeller shaft to the rear differential device, a driving force according to a control current supplied from a control device. Thus, a driving force generated in an engine that is a driving source can be distributed to the main driving wheels and the sub-driving wheels, steplessly within a range from 100:0 to 50:50. To improve the turning performance, the control device of the four-wheel-drive vehicle described in JP 2014-118074 A controls the electronic control coupling so as to reduce the driving force to be distributed to the rear wheels when the rotation speed of an inner wheel of the front wheels is equal to or lower than the rotation speed of an outer wheel thereof.

### SUMMARY

When shifting from a forward moving state to a turning state, a four-wheel-drive vehicle configured as described above may experience a decrease in turning responsiveness at the start of turning of the main driving wheels that are front wheels. The inventors of this application have found that this decrease in turning responsiveness can be avoided through adjustment of the distribution of the driving force between the main driving wheels and the sub-driving wheels.

This disclosure provides a four-wheel-drive vehicle that includes main driving wheels turned by a turning device and sub-driving wheels to which a driving force is transmitted through a driving force transmission device, and that can achieve good turning responsiveness at the start of turning of the main driving wheels.

This disclosure provides a four-wheel-drive vehicle including: a driving source; main driving wheels and sub-driving wheels driven by a driving force of the driving source; a turning device that turns the main driving wheels; a driving force transmission device that transmits part of the driving force of the driving source to the sub-driving wheels; and a control device that controls the driving force transmission device. When the vehicle moves straight forward, the control device adjusts the driving force transmitted to the sub-driving wheels by the driving force transmission device so as to maintain a state where a magnitude of a front-rear force generated in the main driving wheels is greater than zero.

The present disclosure allows a four-wheel-drive vehicle that includes main driving wheels turned by a turning device and sub-driving wheels to which a driving force is transmitted through a driving force transmission device to achieve good turning responsiveness at the start of turning of the main driving wheels.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a simplified view showing an example of the configuration of a four-wheel-drive vehicle according to an embodiment of the present disclosure;

FIG. 2 is a schematic view showing an example of the configuration of a turning device;

FIG. 3 is a simplified configuration view of a right front wheel and its surroundings as seen from a rear side in a vehicle front-rear direction;

FIG. 4 is a simplified configuration view of the right front wheel and its surroundings as seen from an upper side in a vehicle-height direction;

FIG. 5 is a configuration view showing an inner ball joint, a tie rod, and an outer ball joint;

FIG. 6 is a graph showing one example of a relationship between a stroke position in rightward and leftward directions from a neutral position of a rack shaft relative to a housing and an axial force generated in the rack shaft;

FIG. 7A is a schematic view showing a relationship between the direction of a front-rear force generated in the right front wheel and the left front wheel and the direction of an axial force generated in the rack shaft due to this front-rear force, when the four-wheel-drive vehicle moves straight forward;

FIG. 7B is a schematic view showing a relationship between the direction of a front-rear force generated in the right front wheel and the left front wheel and the direction of an axial force generated in the rack shaft due to this front-rear force, when the four-wheel-drive vehicle moves straight forward;

FIG. 8 is a graph showing one example of relationships between a slip ratio of the right front wheel and the left front wheel and a coefficient of front-rear friction;

FIG. 9 is a table showing relationships among whether a front-rear force F of the right front wheel and the left front wheel is positive or negative, whether a front-rear wheel rotation speed difference ΔN that is a difference between a mean rotation speed of the right front wheel and the left front wheel and a mean rotation speed of the right rear wheel and the left rear wheel is positive or negative, and control performed by a control device; and

FIG. 10 is a flowchart showing one example of processes executed by the control device.

### DETAILED DESCRIPTION OF EMBODIMENTS

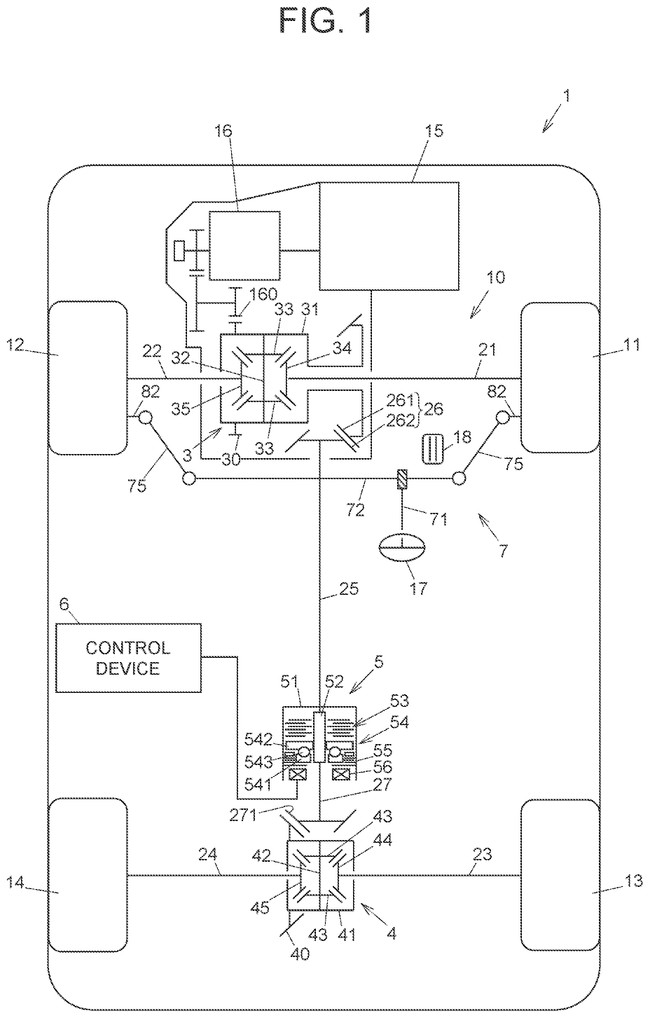

An embodiment of this disclosure will be described with reference to FIG. 1 to FIG. 10. The embodiment to be described below is shown as a specific example that is suitable for implementing this disclosure. While some parts of the embodiment specifically illustrate various technical matters that are technically preferable, the technical scope of this disclosure is not limited to these specific aspects.

FIG. 1 is a simplified view showing an example of the configuration of a four-wheel-drive vehicle 1 according to an embodiment of this disclosure. A four-wheel-drive vehicle 1 includes: a right front wheel 11 and a left front wheel 12 as main driving wheels and a right rear wheel 13 and a left rear wheel 14 as sub-driving vehicles; an engine 15 as a driving source; a transmission 16 that changes the speed of rotation of an output shaft of the engine 15; and a driving force transmission system 10 that transmits the driving force of the engine 15 having been changed in speed by the transmission 16 to the right front wheel 11 and the left front wheel 12 as well as to the right rear wheel 13 and the left rear wheel 14. The right front wheel 11 and the left front wheel 12 as well as the right rear wheel 13 and the left rear wheel 14 are driven by the driving force of the engine 15. For example, an electric motor may be used as the driving source, or the driving source may be formed by a so-called hybrid system combining an engine and an electric motor.

The driving force transmission system 10 includes: left and right driveshafts 21, 22 on the front wheel side; left and right driveshafts 23, 24 on the rear wheel side; a front differential 3; a rear differential 4; a propeller shaft 25 that transmits a driving force in a vehicle front-rear direction; a gear mechanism 26 disposed between the front differential 3 and the propeller shaft 25; a driving force transmission device 5 that transmits part of the driving force of the engine 15 to the right rear wheel 13 and the left rear wheel 14; a pinion gear shaft 27 disposed between the driving force transmission device 5 and the rear differential 4; and a control device 6 that controls the driving force transmission device 5. The driving force transmission device 5 is disposed between the propeller shaft 25 and the rear differential 4, and transmits a driving force corresponding to a control current supplied from the control device 6 toward the right rear wheel 13 and the left rear wheel 14.

The four-wheel-drive vehicle 1 further includes a turning device 7 that turns the right front wheel 11 and the left front wheel 12. In this embodiment, a case where the right front wheel 11 and the left front wheel 12 are turned according to a driver's steering operation of a steering wheel 17 will be described. However, this disclosure is not limited thereto, and the four-wheel-drive vehicle 1 may be a self-driving vehicle of which the driving operation is performed partially or entirely autonomously. The turning device 7 may be of steer-by-wire type.

The front differential 3 has: a ring gear 30 meshed with an output gear 160 of the transmission 16; a front differential case 31 on which the ring gear 30 is fixed; a pinion shaft 32 that rotates integrally with the front differential case 31; a pair of pinion gears 33 that is rotatably supported on the pinion shaft 32; and first and second side gears 34, 35 that are meshed with the pair of pinion gears 33 with the axes of gears orthogonal to each other, and the front differential 3 distributes a driving force to the right front wheel 11 and the left front wheel 12. The left and right driveshafts 21, 22 on the front wheel side are coupled to the first and second side gears 34, 35, respectively, so as to be unable to rotate relative to the first and second side gears 34, 35.

The driving force of the engine 15 having been changed in speed by the transmission 16 is transmitted from the output gear 160 of the transmission 16 to the front differential case 31 via the ring gear 30 of the front differential 3, and is transmitted from the front differential case 31 to the propeller shaft 25 through the gear mechanism 26. The gear mechanism 26 is, for example, a hypoid gear pair, and is formed by meshing with each other a ring gear 261 that rotates integrally with the front differential case 31 and a pinion gear 262 that is coupled to one end of the propeller shaft 25. The other end of the propeller shaft 25 is coupled to the driving force transmission device 5 through, for example, a cross joint (not shown).

The driving force transmission device 5 includes: a housing 51 which has a shape of a cylinder closed at one end and to which a driving force from the propeller shaft 25 is input; an inner shaft 52 that is supported so as to be able to rotate relative to the housing 51 on the same axis; a multi-disc clutch 53 composed of a plurality of clutch plates disposed between the housing 51 and the inner shaft 52; a cam mechanism 54 that generates a pressing force for pressing the multi-disc clutch 53; an electromagnetic clutch 55 that transmits an activation force for activating the cam mechanism 54; and an electromagnetic coil 56 to which a control current is supplied from the control device 6.

When a current is applied to the electromagnetic coil 56, the electromagnetic clutch 55 is engaged by the generated magnetic force, so that part of a torque of the housing 51 is transmitted to a pilot cam 541 of the cam mechanism 54 by the electromagnetic clutch 55. The cam mechanism 54 includes the pilot cam 541 and a main cam 542 that can rotate relative to each other within a predetermined angular range, and a plurality of cam balls 543 that can roll between the pilot cam 541 and the main cam 542. A cam groove in which the cam balls 543 roll is formed in each of the pilot cam 541 and the main cam 542 so as to be inclined relative to the circumferential direction thereof.

The main cam 542 is movable in an axial direction, and unable to rotate, relative to the inner shaft 52. When the pilot cam 541 rotates relative to the main cam 542 due to a torque transmitted by the electromagnetic clutch 55, the cam balls 543 roll in the cam grooves and the main cam 542 is separated from the pilot cam 541. Thus, the multi-disc clutch 53 is pressed and the clutch plates come into frictional contact with one another, so that the driving force is transmitted between the housing 51 and the inner shaft 52. The driving force transmitted by the multi-disc clutch 53 varies according to the magnitude of the control current supplied to the electromagnetic coil 56. By changing the magnitude of the control current supplied to the electromagnetic coil 56, the control device 6 can increase or decrease the driving force to be transmitted to the right rear wheel 13 and the left rear wheel 14.

For example, when the four-wheel-drive vehicle 1 travels straight forward and the multi-disc clutch 53 is pressed to such an extent that rotation of the clutch plates relative to one another does not occur, the ratio between the driving forces distributed to the front wheels and the rear wheels becomes 50:50. When the multi-disc clutch 53 is not pressed and the driving force transmitted by the driving force transmission device 5 is zero, the ratio between the driving forces distributed to the front wheels and the rear wheels becomes 100 (front wheels):0 (rear wheels).

The pinion gear shaft 27 is coupled to the inner shaft 52 of the driving force transmission device 5 so as to be unable to rotate relative to the inner shaft 52. The pinion gear shaft 27 has a gear part 271 at one end, and this gear part 271 meshes with a ring gear 40 of the rear differential 4.

The rear differential 4 has: the ring gear 40; a rear differential case 41 on which the ring gear 40 is fixed; a pinion shaft 42 that rotates integrally with the rear differential case 41; a pair of pinion gears 43 rotatably supported on the pinion shaft 42; and first and second side gears 44, 45 that mesh with the pair of pinion gears 43 with the axes of gears orthogonal to each other. The rear differential 4 distributes a driving force input from the ring gear 40 to the right rear wheel 13 and the left rear wheel 14. The left and right driveshafts 23, 24 on the rear wheel side are coupled to the first and second side gears 44, 45, respectively, so as to be unable to rotate relative to the first and second side gears 44, 45.

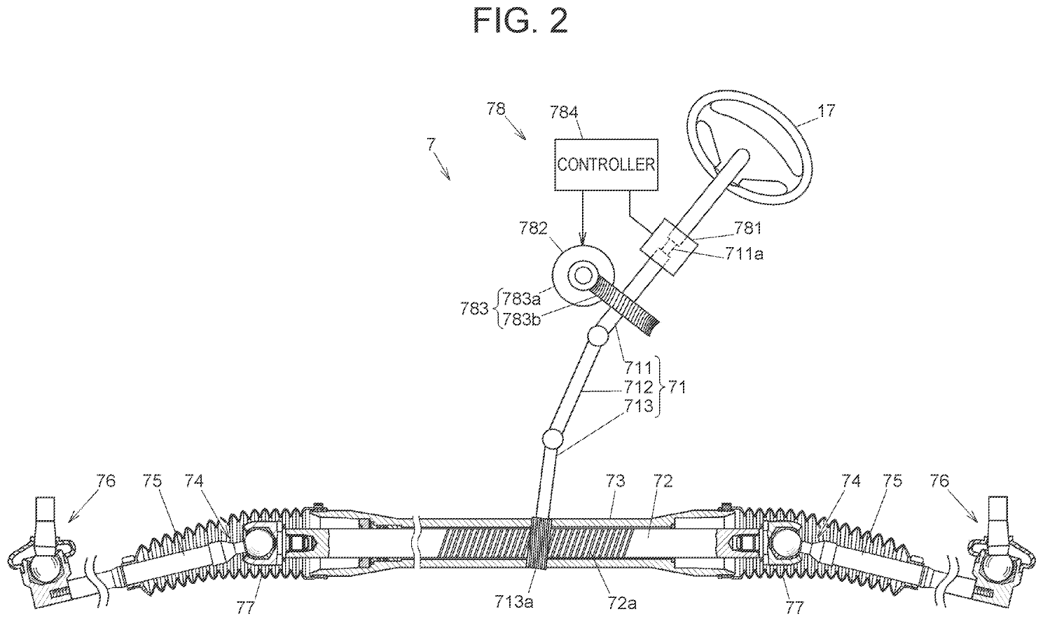

FIG. 2 is a schematic view showing an example of the configuration of the turning device 7. FIG. 2 shows a state where the turning device 7 is seen from a vehicle front side, and the left side and the right side of FIG. 2 correspond to a vehicle right side and a vehicle left side, respectively.

The turning device 7 includes: a steering shaft 71 that rotates according to steering operation of the steering wheel 17; a rack shaft 72 that moves in an axial direction as the steering shaft 71 rotates, and thereby turns the right front wheel 11 and the left front wheel 12 that are turning wheels; a housing 73 that houses the rack shaft 72; inner ball joints 74 respectively mounted on both ends of the rack shaft 72; tie rods 75 each coupled at one end to the rack shaft 72 through the inner ball joint 74; outer ball joints 76 each mounted on the other end of the tie rod 75; bellows 77 each having an accordion structure and disposed so as to cover part of the tie rod 75; and a steering assistance device 78 that assists steering operation of the steering wheel 17.

The steering shaft 71 has a column shaft 711 having the steering wheel 17 fixed at one end, a pinion shaft 713 having pinion teeth 713a that mesh with rack teeth 72a of the rack shaft 72, and an intermediate shaft 712 interposed between the column shaft 711 and the pinion shaft 713. The column shaft 711 has a torsion bar 711a that is twisted by a steering torque.

The steering assistance device 78 has a torque sensor 781 that detects a steering torque applied to the steering wheel 17 based on an amount of twisting of the torsion bar 711a, an electric motor 782, a worm gear mechanism 783, and a controller 784 that controls the electric motor 782. The worm gear mechanism 783 has a worm 783a that is driven by the electric motor 782, and a worm wheel 783b that meshes with the worm 783a. The worm gear mechanism 783 transmits a steering assistance force that is a torque of the electric motor 782 having been decelerated and thereby amplified from the worm wheel 783b to the steering shaft 71.

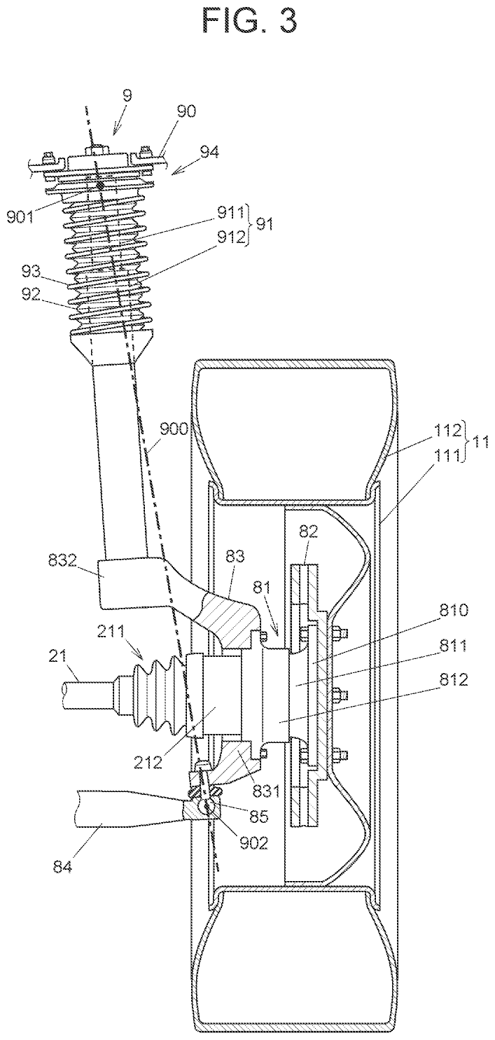

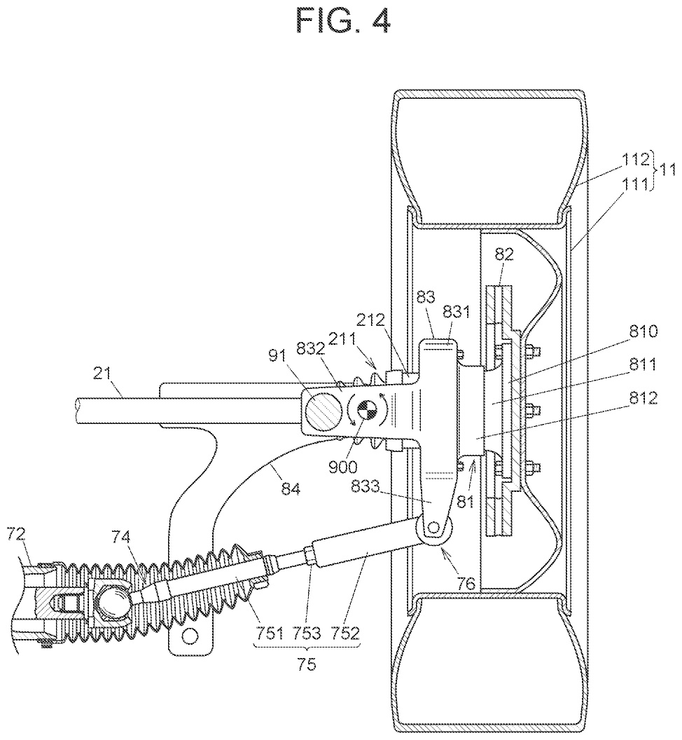

FIG. 3 is a simplified configuration view of the right front wheel 11 and its surroundings as seen from the rear side in the vehicle front-rear direction. FIG. 4 is a simplified configuration view of the right front wheel 11 and its surroundings as seen from an upper side in a vehicle-height direction. The right front wheel 11 has a metal wheel 111 and a tire 112 mounted on an outer circumference of the wheel 111. A hub unit 81 is disposed so as to be interposed between the wheel 111 and the driveshaft 21.

The hub unit 81 has a hub ring 811 having a flange 810 on which the wheel 111 and a brake disc 82 are mounted, and a cylindrical outer ring 812 disposed on an outer circumference of the hub ring 811. An outer race 212 of a constant-speed joint 211 provided at an end of the driveshaft 21 is mounted on the hub ring 811 so as to be unable to rotate relative to the hub ring 811. In FIG. 3 and FIG. 4, a disc brake device that brakes the right front wheel 11 by generating a frictional force on the brake disc 82 is not shown.

The outer ring 812 of the hub unit 81 is fixed on a knuckle 83 supported by a suspension device 9. The knuckle 83 has an annular main part 831 surrounding the outer ring 812 of the hub unit 81, a first arm 832 extending obliquely upward from an upper end of the main part 831, and a second arm 833 extending from the main part 831 toward a rear side in the vehicle front-rear direction. A lower end of the main part 831 is coupled by a lower arm 84 and a knuckle joint 85.

The suspension device 9 has a shock absorber 91, an accordion-shaped boot 92 that covers the shock absorber 91, a coil spring 93 disposed on an outer circumference of the boot 92, and an upper support 94 mounted on a vehicle body 90. The shock absorber 91 has a strut rod 911 and a cylinder 912. In FIG. 3, the strut rod 911 disposed inside the boot 92 is indicated by dashed lines. An upper end of the strut rod 911 is supported on the upper support 94.

A straight line connecting a joint point 901 at an upper end of the strut rod 911 and a joint point 902 of the knuckle joint 85 to each other is a king pin axis 900, and when steering operation of the steering wheel 17 is performed, the knuckle 83 rotates along with the hub unit 81 and the wheel 111 around this king pin axis 900 as a rotational axis.

The tie rod 75 is coupled to a leading end of the second arm 833 of the knuckle 83 through the outer ball joint 76. When the rack shaft 72 moves in the axial direction relative to the housing 73, the second arm 833 of the knuckle 83 is pressed or pulled by the tie rod 75, so that the knuckle 83 rotates along with the hub unit 81 and the wheel 111 around the king pin axis 900 as a rotational axis, thus turning the right front wheel 11. The surroundings of the left front wheel 12 are configured in the same manner as has been described above.

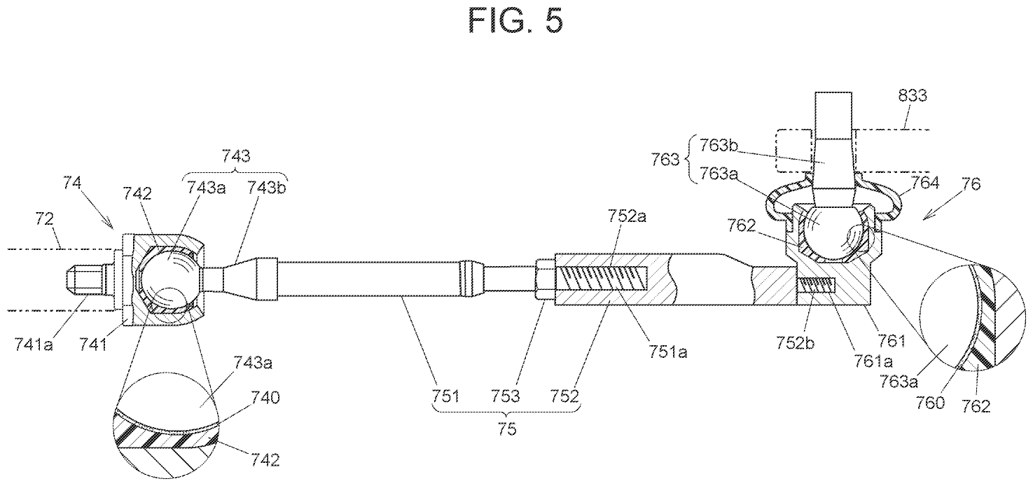

FIG. 5 is a configuration view showing the inner ball joint 74, the tie rod 75, and the outer ball joint 76. The inner ball joint 74 has a socket 741 coupled to an end of the rack shaft 72, a cup-shaped resin sheet 742 housed in the socket 741, and a ball stud 743 swingable relative to the socket 741 and the resin sheet 742. The socket 741 has an external thread 741a that engages with the rack shaft 72. The ball stud 743 has a spherical head part 743a having a spherical shape and a stud part 743b formed integrally with the spherical head part 743a. The spherical head part 743a is covered with the resin sheet 742, and the stud part 743b protrudes from the socket 741.

The tie rod 75 has a first rod part 751 that is integrated with the stud part 743b of the ball stud 743, a second rod part 752 that has an internally threaded hole 752a with which an external thread 751a provided on the first rod part 751 engages, and a nut 753 that engages with the external thread 751a of the first rod part 751. An amount that the external thread 751a is screwed into the internally threaded hole 752a is variable according to rotation of the first rod part 751 and the second rod part 752 relative to each other, and is fixed by the nut 753. By adjusting the amount that the external thread 751a is screwed into the internally threaded hole 752a, the toe-in angles of the right front wheel 11 and the left front wheel 12 that are turning wheels can be adjusted.

The outer ball joint 76 includes a socket 761 having a shape of a cylinder closed at one end, a resin sheet 762 housed inside the socket 761, a ball stud 763 swingably supported by the socket 761 and the resin sheet 762, and a cover 764 covering a gap between the socket 761 and the ball stud 763. An internally threaded hole 761a with which an external thread 752b of the second rod part 752 engages is formed in the socket 761. The ball stud 763 has a spherical head part 763a having a spherical shape and a stud part 763b integrally formed with the spherical head part 763a, and can rotate and swing relative to the socket 761. The stud part 763b is fixed to a leading end of the second arm 833 of the knuckle 83.

As shown in close-up in FIG. 5, grease 740 is interposed between the resin sheet 742 of the inner ball joint 74 and the spherical head part 743a of the ball stud 743. Similarly, grease 760 is interposed between the resin sheet 762 of the outer ball joint 76 and the spherical head part 763a of the ball stud 763. These greases 740, 760 allow smooth sliding of the resin sheet 742 of the inner ball joint 74 and the spherical head part 743a of the ball stud 743, and smooth sliding of the resin sheet 762 of the outer ball joint 76 and the spherical head part 763a of the ball stud 763.

On the other hand, these greases 740, 760 cause formation of play (clearance) in the inner ball joint 74 and the outer ball joint 76, thus constituting a contributing factor for a decrease in turning responsiveness at the start of turning in steering operation. This decrease in responsiveness may cause the driver to feel that the steering reaction force is discontinuous when the driver starts steering operation of the steering wheel 17.

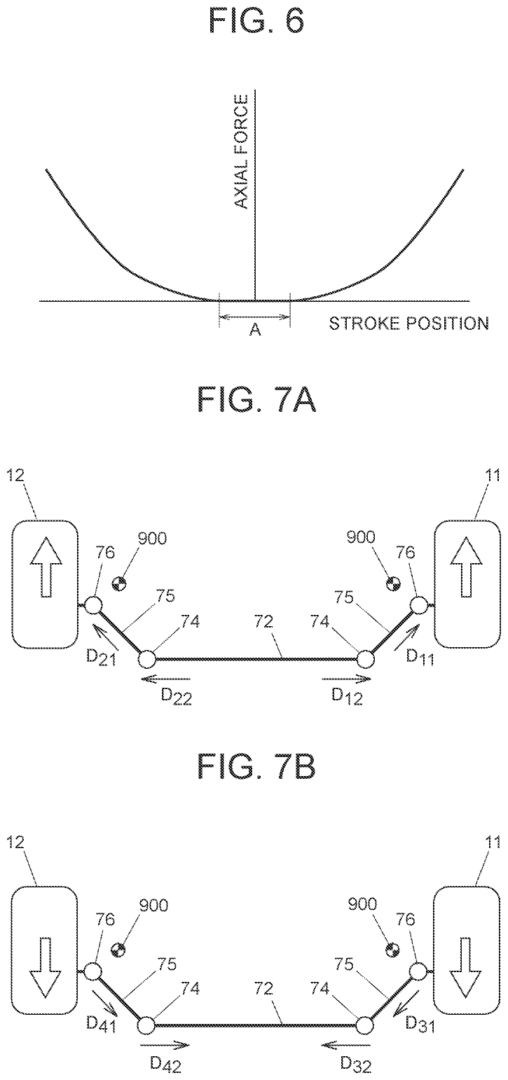

FIG. 6 is a graph showing one example of a relationship between a stroke position in rightward and leftward directions from the neutral position of the rack shaft 72 relative to the housing 73 and an axial force generated in the rack shaft 72. As shown in this graph, the axial force of the rack shaft 72 does not increase until the play in the inner ball joint 74 and the outer ball joint 76 is eliminated, and when the play in the inner ball joint 74 and the outer ball joint 76 has been eliminated and the resin sheets 742, 762 start to deform, the axial force of the rack shaft 72 increases gradually. As the amount of deformation of the resin sheets 742, 762 increases, the axial force of the rack shaft 72 increases gradually at a higher rate. In FIG. 6, the range of play in the inner ball joint 74 and the outer ball joint 76 is indicated by the double arrow A.

FIG. 7A and FIG. 7B are schematic views showing a relationship between the direction of a front-rear force generated in the right front wheel 11 and the left front wheel 12 and the direction of an axial force generated in the rack shaft 72 due to this front-rear force when the four-wheel-drive vehicle 1 moves straight forward. FIG. 7A shows a state where a front-rear force in an acceleration direction is generated in the right front wheel 11 and the left front wheel 12, and FIG. 7B shows a state where a front-rear force in a deceleration direction is generated in the right front wheel 11 and the left front wheel 12. Here, a front-rear force refers to a frictional force, i.e., a braking force in an acceleration or deceleration direction generated between a road surface and a tire.

When the four-wheel-drive vehicle 1 moves straight forward and a front-rear force in the acceleration direction is generated in the right front wheel 11 and the left front wheel 12, the play in the inner ball joint 74 and the outer ball joint 76 is eliminated in the directions indicated by arrows D₁₁, D₁₂, D₂₁, D₂₂ in FIG. 7A. When a front-rear force in the deceleration direction is generated in the right front wheel 11 and the left front wheel 12, the play in the inner ball joint 74 and the outer ball joint 76 is eliminated in the directions indicated by arrows D₃₁, D₃₂, D₄₁, D₄₂ in FIG. 7B. When the direction of the front-rear force in the right front wheel 11 and the left front wheel 12 is reversed, the state shown in FIG. 7A and the state shown in FIG. 7B are switched from one to the other.

In a state between the state shown in FIG. 7A and the state shown in FIG. 7B, i.e., a state where the torque transmitted from the engine 15 to the right front wheel 11 and the left front wheel 12 and the rotational resistance force of the right front wheel 11 and the left front wheel 12 match and the front-rear force of the right front wheel 11 and the left front wheel 12 is near zero, the play in the inner ball joint 74 and the outer ball joint 76 is not eliminated. When the rack shaft 72 starts to move in this state, the play in the inner ball joint 74 and the outer ball joint 76 is eliminated first before the knuckle 83 starts to rotate around the king pin axis 900, which results in a decrease in turning responsiveness of the right front wheel 11 and the left front wheel 12.

In this embodiment, therefore, this decrease in turning responsiveness is mitigated through adjustment of the distribution of the driving force to the right front wheel 11 and the left front wheel 12 and to the right rear wheel 13 and the left rear wheel 14. Specifically, when the vehicle moves straight forward, the control device 6 adjusts the driving force transmitted to the right rear wheel 13 and the left rear wheel 14 by the driving force transmission device 5 so as to maintain a state where the magnitude of the front-rear force generated in the right front wheel 11 and the left front wheel 12 is greater than zero.

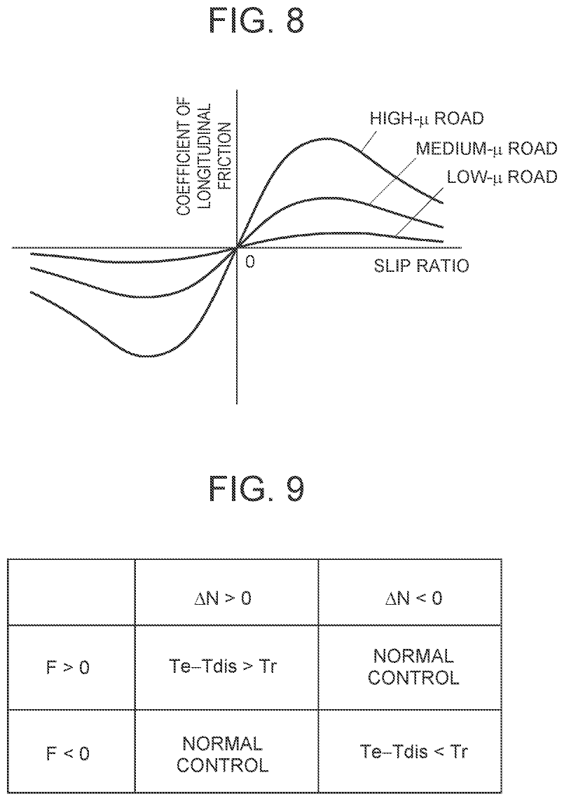

For example, the front-rear force of the right front wheel 11 and the left front wheel 12 when the four-wheel-drive vehicle 1 moves straight forward can be obtained with reference to a map, for example, based on a load and a slip ratio of the right front wheel 11 and the left front wheel 12. FIG. 8 is a graph showing one example of relationships between a slip ratio and a coefficient of front-rear friction of the right front wheel 11 and the left front wheel 12. This graph shows relationships between the slip ratio and the coefficient of front-rear friction when the vehicle travels on a high-μ road, such as a dry paved road, when the vehicle travels on a medium-μ road, such as a paved road in a wet state, and when the vehicle travels on a low-μ road, such as a frozen road. The front-rear force of the right front wheel 11 and the left front wheel 12 can be obtained by multiplying the coefficient of front-rear friction, which can be obtained with reference to a map storing, as map values, the characteristics of the graph shown in FIG. 8, by the load of the right front wheel 11 and the left front wheel 12. Alternatively, the front-rear force of the right front wheel 11 and the left front wheel 12 may be detected by, for example, a strain gauge, or the front-rear force of the right front wheel 11 and the left front wheel 12 may be obtained by a calculation based on a detection value of an acceleration sensor that detects a rate of acceleration in the front-rear direction.

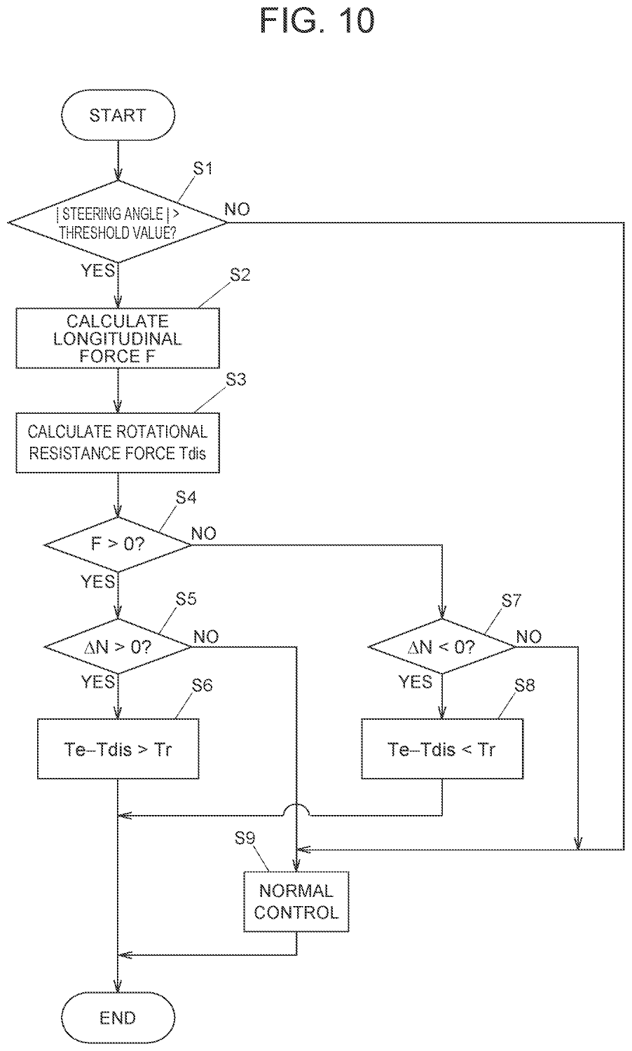

FIG. 9 is a table showing relationships among whether a front-rear force F of the right front wheel 11 and the left front wheel 12 is positive or negative, whether a front-rear wheel rotation speed difference ΔN that is a difference between a mean rotation speed of the right front wheel 11 and the left front wheel 12 and a mean rotation speed of the right rear wheel 13 and the left rear wheel 14 is positive or negative, and control performed by the control device 6. Here, the front-rear force F is positive (F>0) when the front-rear force of the right front wheel 11 and the left front wheel 12 is in the acceleration direction, and the front-rear force F is negative (F<0) when the front-rear force is in the deceleration direction. As for the front-rear wheel rotation speed difference, it is positive (ΔN>0) when the mean rotation speed of the right front wheel 11 and the left front wheel 12 is higher than the mean rotation speed of the right rear wheel 13 and the left rear wheel 14, and it is negative (ΔN<0) in the reverse case. The variables shown in FIG. 9 are defined as follows.

Te is a magnitude of an engine torque that is a torque generated by the engine 15 as converted into a torque of the driveshafts 21, 22 on the front wheel side based on a gear ratio of the transmission 16 and a gear ratio between the output gear 160 of the transmission 16 and the ring gear 30. Tf is a magnitude of a torque of the engine 15 transmitted to the driveshafts 21, 22. Tr is a converted value that is a magnitude of a torque transmitted toward the right rear wheel 13 and the left rear wheel 14 via the driving force transmission device 5 as converted into a torque value of the driveshafts 21, 22 on the front wheel side based on a gear ratio of the gear mechanism 26. Tdis is a magnitude of a rotational resistance force (disturbance torque) of the right front wheel 11 and the left front wheel 12 attributable to rolling resistance, road resistance, etc. to the right front wheel 11 and the left front wheel 12.

Here, Te can be acquired from information from an engine controller that controls the engine 15. Tr can be obtained based on a control current supplied to the electromagnetic coil 56 of the driving force transmission device 5. Tf can be obtained from a calculation formula Tf=Te−Tr. The magnitude of the rotational resistance force (Tdis) is a value that varies according to the vehicle speed, the load, the road surface conditions, etc., and can be estimated, for example, with reference to a map in which results obtained by experiment or simulation are recorded as map information.

As shown in FIG. 9, the control device 6 controls the driving force transmission device 5 such that Te−Tdis>Tr, in other words, Tf>Tdis is met when the front-rear force F is positive and the front-rear wheel rotation speed difference ΔN is positive. Thus, when the front-rear force F is positive and the front-rear wheel rotation speed difference ΔN is positive, a state where the transmission torque transmitted from the engine 15 to the right front wheel 11 and the left front wheel 12 is greater than the rotational resistance force of the right front wheel 11 and the left front wheel 12 is maintained. That is, the state of the four-wheel-drive vehicle 1 is maintained in the state shown in FIG. 7A.

The control device 6 controls the driving force transmission device 5 such that Te−Tdis<Tr, in other words, Tf<Tdis is met when the front-rear force F is negative and the front-rear wheel rotation speed difference ΔN is also negative. Thus, a state where the transmission torque transmitted from the engine 15 to the right front wheel 11 and the left front wheel 12 is smaller than the rotational resistance force of the right front wheel 11 and the left front wheel 12 is maintained. That is, the state of the four-wheel-drive vehicle 1 is maintained in the state shown in FIG. 7B.

The control device 6 performs normal control when the front-rear force F is positive and the front-rear wheel rotation speed difference ΔN is negative and when the front-rear force F is negative and the front-rear wheel rotation speed difference ΔN is positive. Examples of this normal control include control that makes the driving force transmitted by the driving force transmission device 5 greater as the absolute value of the front-rear wheel rotation speed difference ΔN becomes larger, and control that makes the driving force transmitted by the driving force transmission device 5 greater as an amount that the driver presses an accelerator pedal 18 becomes larger.

FIG. 10 is a flowchart showing one example of processes executed by the control device 6 when the four-wheel-drive vehicle 1 travels forward. The control device 6 executes the process shown in this flowchart once every predetermined control period (e.g., 5 ms).

In the process shown in this flowchart, the control device 6 first determines whether the absolute value of the steering angle of the steering wheel 17 is smaller than a predetermined threshold value (step S1). The threshold value in step S1 is a value at which the result of determination in step S1 becomes Yes only when the four-wheel-drive vehicle 1 is in a state of practically moving straight forward. When the result of this determination is Yes, the control device 6 calculates the front-rear force F of the right front wheel 11 and the left front wheel 12 (step S2), and calculates the rotational resistance force Tdis of the right front wheel 11 and the left front wheel 12 (step S3).

Next, the control device 6 determines whether the front-rear force F of the right front wheel 11 and the left front wheel 12 is positive (step S4). When the result of this determination is Yes, the control device 6 determines whether the front-rear wheel rotation speed difference ΔN is positive (step S5), and, when the result of this determination is Yes, controls the driving force transmission device 5 such that Te−Tdis>Tr is met (step S6). When the result of determination in step S4 is No, the control device 6 determines whether the front-rear wheel rotation speed difference ΔN is negative (step S7), and, when the result of this determination is Yes, controls the driving force transmission device 5 such that Te−Tdis<Tr is met (step S8). When the result of determination in any one of steps S1, S5, and S7 is No, the control device 6 performs the above-described normal control (step S9).

Thus, when the four-wheel-drive vehicle 1 moves straight forward, the control device 6 estimates the magnitudes of the front-rear force and the rotational resistance force of the right front wheel 11 and the left front wheel 12. When the direction of the front-rear force generated in the right front wheel 11 and the left front wheel 12 is the acceleration direction (F>0) and moreover the rotation speed of the right front wheel 11 and the left front wheel 12 is higher than the rotation speed of the right rear wheel 13 and the left rear wheel 14 (ΔN>0), the control device 6 adjusts the driving force transmitted by the driving force transmission device 5 so as to maintain a state where the transmission torque transmitted from the engine 15 to the right front wheel 11 and the left front wheel 12 is greater than the estimated value of the magnitude of the rotational resistance force of the right front wheel 11 and the left front wheel 12.

When the four-wheel-drive vehicle 1 moves straight forward, and the direction of the front-rear force generated in the right front wheel 11 and the left front wheel 12 is the deceleration direction (F<0) and moreover the rotation speed of the right front wheel 11 and the left front wheel 12 is lower than the rotation speed of the right rear wheel 13 and the left rear wheel 14 (ΔN<0), the control device 6 adjusts the driving force transmitted by the driving force transmission device 5 so as to maintain a state where the transmitted torque transmitted from the engine 15 to the right front wheel 11 and the left front wheel 12 does not exceed the estimated value of the magnitude of the rotational resistance force of the right front wheel 11 and the left front wheel 12.

According to the embodiment having been described above, when the four-wheel-drive vehicle 1 moves straight forward, the state shown in FIG. 7A or the state shown in FIG. 7B is maintained, which allows good turning responsiveness at the start of turning of the right front wheel 11 and the left front wheel 12.

While this disclosure has been described above based on the embodiment, this embodiment does not limit the scope of the claims. It should be noted that not all the combinations of features described in the embodiment are essential for the solutions to the problem adopted by this disclosure. This disclosure can be implemented with changes, such as omission of some components or addition or substitution of components, made thereto as necessary within the gist of the disclosure. Moreover, this disclosure can also be implemented, for example, with the following changes made thereto.

In the above-described embodiment, the case has been described where, when the four-wheel-drive vehicle 1 moves straight forward, the processing of step S6 is executed when the direction of the front-rear force generated in the right front wheel 11 and the left front wheel 12 is the acceleration direction (F>0) and moreover the rotation speed of the right front wheel 11 and the left front wheel 12 is higher than the rotation speed of the right rear wheel 13 and the left rear wheel 14 (ΔN>0), and the processing of step S8 is executed when the direction of the front-rear force generated in the right front wheel 11 and the left front wheel 12 is the deceleration direction (F<0) and moreover the rotation speed of the right front wheel 11 and the left front wheel 12 is lower than the rotation speed of the right rear wheel 13 and the left rear wheel 14 (ΔN<0). However, the processing of step S6 may be executed regardless of the front-rear wheel rotation speed difference ΔN when the direction of the front-rear force generated in the right front wheel 11 and the left front wheel 12 is the acceleration direction, and the processing of step S8 may be executed regardless of the front-rear wheel rotation speed difference ΔN when the direction of the front-rear force generated in the right front wheel 11 and the left front wheel 12 is the deceleration direction. This means that the determinations in steps S5 and S7 of the flowchart shown in FIG. 10 may be omitted.

The configuration of the four-wheel-drive vehicle 1 is not limited to the one illustrated in FIG. 1 but can be changed as necessary. For example, the driving force transmission device 5 may be disposed between the rear differential 4 and the right rear wheel 13 or the left rear wheel 14.

What is claimed is:

1. A four-wheel-drive vehicle comprising:
a driving source;
main driving wheels and sub-driving wheels driven by a driving force of the driving source;
a turning device that turns the main driving wheels;
a driving force transmission device that transmits part of the driving force of the driving source to the sub-driving wheels; and
a control device that controls the driving force transmission device, the control device being configured to, when the vehicle moves straight forward, adjust the driving force transmitted to the sub-driving wheels by the driving force transmission device so as to maintain a state where a magnitude of a front-rear force generated in the main driving wheels is greater than zero.

2. The four-wheel-drive vehicle according to claim 1, wherein the control device is configured to:
estimate magnitudes of the front-rear force and a rotational resistance force of the main driving wheels when the vehicle moves straight forward;
when a direction of the front-rear force generated in the main driving wheels is an acceleration direction, adjust the driving force transmitted by the driving force transmission device so as to maintain a state where a transmission torque transmitted from the driving source to the main driving wheels is greater than an estimated value of the magnitude of the rotational resistance force; and
when the direction of the front-rear force generated in the main driving wheels is a deceleration direction, adjust the driving force transmitted by the driving force transmission device so as to maintain a state where the transmission torque transmitted from the driving source to the main driving wheels does not exceed the estimated value of the magnitude of the rotational resistance force.

3. The four-wheel-drive vehicle according to claim 1, wherein the control device is configured to:
estimate magnitudes of the front-rear force and a rotational resistance force of the main driving wheels when the vehicle moves straight forward; and
when a direction of the front-rear force generated in the main driving wheels is an acceleration direction and moreover a rotation speed of the main driving wheels is higher than a rotation speed of the sub-driving wheels, adjust the driving force transmitted by the driving force transmission device so as to maintain a state where a transmission torque transmitted from the driving source to the main driving wheels is greater than an estimated value of the magnitude of the rotational resistance force.

4. The four-wheel-drive vehicle according to claim 1, wherein the control device is configured to:
estimate magnitudes of the front-rear force and a rotational resistance force of the main driving wheels when the vehicle moves straight forward; and
when a direction of the front-rear force generated in the main driving wheels is a deceleration direction and moreover a rotation speed of the main driving wheels is lower than a rotation speed of the sub-driving wheels, adjust the driving force transmitted by the driving force transmission device so as to maintain a state where a transmission torque transmitted from the driving source to the main driving wheels does not exceed an estimated value of the magnitude of the rotational resistance force.
